(19) United States
(12) Patent Application Publication
(10) Pub. No.: US 2025/0062538 A1
(43) Pub. Date: Feb. 20, 2025

(54) ADDITIVELY MANUFACTURED ANTENNA WITH INVERTED HAT MONOPOLE ELEMENT

(71) Applicant: BAE SYSTEMS Information and Electronic Systems Integration Inc., Nashua, NH (US)

(72) Inventors: Alexander D. Johnson, Waltham, MA (US); James F. Fung, Manchester, NH (US)

(73) Assignee: BAE SYSTEMS Information and Electronic Systems Integration Inc., Nashua, NH (US)

(21) Appl. No.: 18/451,396

(22) Filed: Aug. 17, 2023

(51) Int. Cl. H01Q 9/30; H01Q 13/02; H01Q 21/00; H01Q 21/20

(52) U.S. Cl. CPC H01Q 9/30; H01Q 13/0283; H01Q 21/0087; H01Q 21/205

(57) ABSTRACT

An antenna assembly includes an electrically conductive ground plane; a signal pin adjacent to the ground plane; and a tapered conductive surface coupled to the signal pin, the tapered conductive surface being symmetric about an axis passing through the signal pin and orthogonal to the ground plane, where the ground plane and the tapered conductive surface are an additively manufactured contiguous unitary component. The antenna assembly can further include a support structure extending from the ground plane to the tapered conductive surface. The support structure can be coupled to an outer edge of the tapered conductive surface or a center region of the tapered conductive surface. The antenna assembly can further include a cover over the tapered conductive surface thereby forming a hollow region between the cover and the tapered conductive surface.

### FIELD OF DISCLOSURE

The present disclosure relates to antennas, and more particularly, to an additively manufactured antenna with an inverted hat monopole element.

### BACKGROUND

Generally, an antenna transduces electromagnetic (EM) waves to radio frequency (RF) electrical signals. An inverted hat antenna is a wideband monopole antenna having a radiator with a surface that tapers away from a ground plane. Inverted hat antennas have a constant or a nearly constant impedance over a large ratio bandwidth of frequencies. Exciting the radiator with an RF signal at the feed causes EM waves to radiate from the radiator. The radiation pattern is a function of the shape and size of the radiator and ground plane. However, there remain a number of non-trivial challenges with respect to designing and manufacturing wideband monopoles such as inverted hat antenna structures.

### BRIEF DESCRIPTION OF THE DRAWINGS

FIG. 1 is a side view of an antenna assembly, in accordance with an example of the present disclosure.

FIG. 2 is a top perspective view of the antenna assembly of FIG. 1, in accordance with an example of the present disclosure.

FIG. 3 is a top perspective view of the antenna assembly of FIG. 1, in accordance with another example of the present disclosure.

FIG. 4 is a side view of an antenna assembly, in accordance with another example of the present disclosure.

FIG. 5 is a side view of an antenna assembly, in accordance with another example of the present disclosure.

FIGS. 6A-D show the antenna assembly of FIG. 1 fabricated at various scales, in accordance with examples of the present disclosure.

FIG. 7A shows the antenna assembly of FIG. 1 arranged in a linear array, in accordance with an example of the present disclosure.

FIG. 7B shows the antenna assembly of FIG. 1 arranged in a circular array, in accordance with an example of the present disclosure.

FIG. 8 is a flow diagram of a method of fabricating an antenna assembly, in accordance with an example of the present disclosure.

Although the following detailed description will proceed with reference being made to illustrative examples, many alternatives, modifications, and variations thereof will be apparent in light of this disclosure.

### DETAILED DESCRIPTION

In accordance with an example of the present disclosure, an antenna assembly includes an electrically conductive ground plane, a signal pin adjacent and perpendicular to the ground plane, and a tapered conductive surface coupled to the signal pin. The signal pin, the ground plane, and the tapered conductive surface are integral to each other as an additively manufactured contiguous unitary component. The tapered conductive surface is symmetric about an axis passing through the signal pin and orthogonal to the ground plane. The tapered conductive surface includes an additively manufactured material. The antenna assembly can further include a support structure extending from the ground plane to the tapered conductive surface. The support structure can include the additively manufactured material. The support structure can be coupled to an outer edge of the tapered conductive surface or a center, or base, region of the tapered conductive surface. The antenna assembly can further include a cover over the tapered conductive surface thereby forming a hollow region between the cover and the tapered conductive surface. The cover can include the additively manufactured material. The antenna assembly can further include an infill material adjacent to one side of the tapered conductive surface. The infill material can include the additively manufactured material. The antenna assembly can further include a feed line electrically coupled to the signal pin. The feed line can include a coaxial cable sealed with a vacuum, an air, a gas, or a solid dielectric therein.

In accordance with another example of the present disclosure, a method of fabricating an antenna assembly includes additively manufacturing a signal pin adjacent to a ground plane, and additively manufacturing a tapered conductive surface coupled to the signal pin. The signal pin, the ground plane, and the tapered conductive surface are integral to each other as an additively manufactured contiguous unitary component. The tapered conductive surface is symmetric about an axis passing through the signal pin and orthogonal to the ground plane. The tapered conductive surface includes an additively manufactured material. In some examples, the method further includes additively manufacturing the ground plane. Numerous configurations and variations will be apparent in light of this disclosure.

### Overview

As noted above, an inverted hat antenna is a type of ultra-wideband monopole antenna with a radiation pattern that is a function of the size and shape of a ground plane and a radiator. Some existing inverted hat antennas are fabricated from a sheet of metal that creates an electrically conductive ground plane and another sheet of metal formed into a hat-shaped structure that creates the radiator. A peak, or stem, of the radiator, which is inverted relative to the ground plane, is mounted to a signal pin at the ground plane. A feed line, such as provided via a coaxial cable, is electrically coupled to the signal pin. A current at the signal pin excites the ground plane, causing an RF signal to radiate outwardly from the ground plane and to diffract at the surface of the radiator. A characteristic of an inverted hat antenna is that the size and shape of the antenna can be adjusted to accommodate different frequency ranges.

However, inverted hat antennas constructed using simple materials, such as sheet metal, may have limited thermal management properties, thus requiring additional cooling or heat dissipation techniques to be employed. Furthermore, existing inverted hat antenna fabrication techniques are not well-suited for packaging active or high-power electronics into the antenna using low loss interconnects. Therefore, there remain a number of non-trivial challenges with respect to designing and manufacturing inverted hat antenna structures.

Accordingly, techniques are described to fabricate an inverted hat antenna using an additive manufacturing process. In an example, an inverted hat antenna fabricated according to the disclosed techniques is a wideband directional antenna that can be used in a variety of RF applications, such as direction finding, communications, and electronic warfare (EW). The antenna, or portions thereof, can be additively manufactured. Examples of such an additive manufacturing process include where one or more components of the antenna are fabricated by the successive addition of material, such as using three-dimensional printing, layering, or other deposition process. By using an additive manufacturing process, the antenna design can (i) be wavelength scaled (e.g., scaled linearly as a function of frequency); (ii) handle high power; and (iii) provide dual functions as an RF and a mechanical structure for packaging electronics. For example, by using additive manufacturing techniques to fabricate the antenna, the integral structure of the radiating antenna can be load bearing and/or can host one or more thermal management features, such as direct liquid cooling channels or convection cooling fins. This is in contrast to existing techniques that employ external structural supports, external fans, or adhesive cooling fins, each of which increase the size, weight, power, and cost of the device. Furthermore, additive manufacturing facilitates production of antennas with high precision and little variation, while easily allowing for design variants to achieve various performance requirements with little to no additional engineering development costs.

In some examples, the antenna can be additively manufactured as a single contiguous piece (a unitary or monolithic structure), or as a combination of additively manufactured and metal machined components, which can improve performance for lower frequency antennas. For example, at least some portions of the antenna structure can be fabricated by additively adding materials selected to improve thermal performance and to integrate impedance matched components into a contiguous unitary structure or sub-structure. By constructing all or portions of the antenna using additive manufacturing, the antenna can thus be configured to handle very high power (e.g., megawatts) without voltage breakdown, such as by avoiding or reducing the use of dielectric transmission lines. The antenna fabricated using additive manufacturing can further be optimized for thermal heat dissipation, with provisions for sealing, with integral feed lines and/or impedance matching features, and/or for scaling from very high frequencies (VHF) to millimeter wave (mmW) while substantially reducing design non-recurring engineering (NRE) costs.

### Antenna Structure

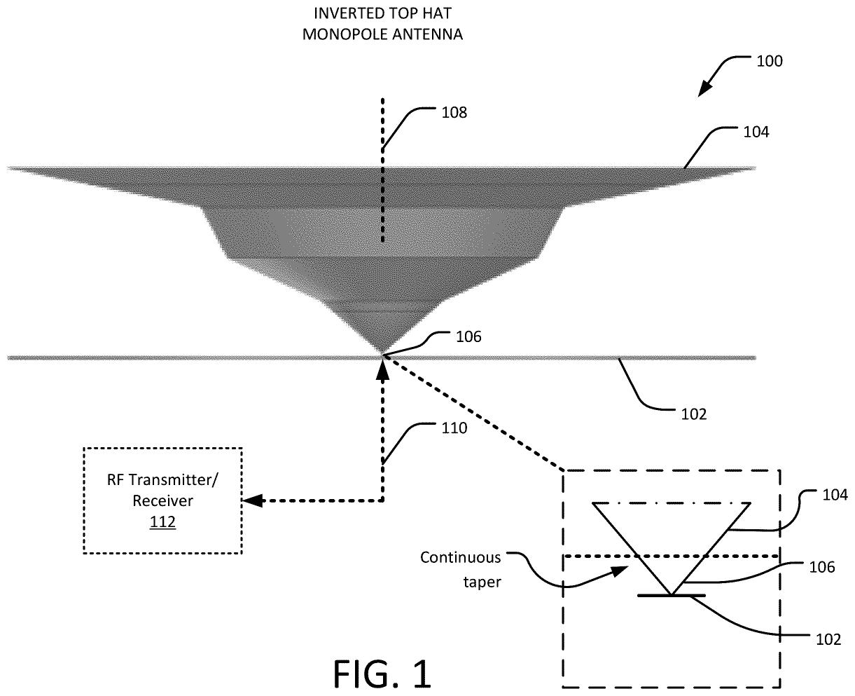

FIG. 1 is a side view of an antenna assembly 100, in accordance with an example of the present disclosure. The antenna assembly 100, also referred to as an inverted hat antenna, is a type of monopole antenna that radiates signals omni-directionally in the azimuth plane. The antenna assembly 100 includes a ground plane 102 and a radiator 104. The ground plane 102 and the radiator 104 are electrically conductive. The radiator 104 is a tapered conductive surface coupled to a signal pin 106, both of which are centered on the ground plane 102. The tapered conductive surface of the radiator 104 is symmetric about an axis 108 passing through the signal pin 106 and orthogonal to the ground plane 102. In some examples, the signal pin 106 is tapered, where the taper of the signal pin 106 is continuous with the taper of the conductive surface of the radiator 104. For example, the width of the signal pin 106 can be greater where the signal pin 106 adjoins the radiator 104 than where the signal pin 106 adjoins the ground plane 102, and the width of the signal pin 106 can be the same or approximately the same as the width of the radiator 104 where the signal pin 106 adjoins the radiator 104.

In some examples, the ground plane 102, the radiator 104, and/or the signal pin 106 include an additively manufactured material. For example, the ground plane 102, the radiator 104, and the signal pin 106 can be fabricated as a contiguous, unitary structure, or as separate components that can be electrically coupled attached together, or using a combination of additive manufacturing and metal machining to fabricate these components. Examples of such an additive manufacturing process include where one or more components of the antenna assembly 100 (e.g., the ground plane 102, the radiator 104, and/or the signal pin 106) are fabricated by the successive addition of material (e.g., via a three-dimensional printing, layering, or other deposition process). For example, the antenna assembly 100, or portions thereof, can be fabricated entirely of metal or any suitable conductive material. For example, the ground plane 102, the radiator 104, and the signal pin 106 can be fabricated from the same or different materials as each other using additive manufacturing where the material(s) are successively added or deposited to form a single contiguous unitary component (as opposed, for instance, to subtractive manufacturing where material is removed from a larger piece to form the component, or to other manufacturing techniques where several components are fabricated separately and subsequently attached, fastened, bonded, coupled, or otherwise joined together). In another example, the antenna assembly 100, or portions thereof, can be fabricated any suitable additive or subtractive manufacturing process, including three-dimensional printing, casting, computer numerical control (CNC), or material deposition. In some examples, the antenna assembly 100, or portions thereof, can be fabricated as a single continuous unit or structure. In some other examples, individual components of the antenna assembly 100 can be fabricated separately and assembled together. In some examples, the antenna assembly 100, or portions thereof, can be fabricated from any suitable material which may be enclosed in, coated with, or otherwise covered with a conductive material, such as a conductive metal, to provide an electrically conductive metal surface. In some examples, at least portions of the antenna assembly 100 can be fabricated using a thermally conductive material (e.g., a solid, a liquid, and/or a gas), and/or in configurations that provide high thermal conductive properties (e.g., a heat sink, cooling fins, air or liquid cooling channels, heat pipes, etc.). In some examples, the antenna assembly 100 can include ceramics or other non-conductive materials that provide a support structure for mounting or otherwise attaching conductive materials.

A feed line 110 can be attached to the signal pin 106 and, for example, to a radio frequency (RF) transmitter and/or an RF receiver 112. In some examples, an interconnect for the feed line 110 can be additively manufactured into the signal pin 106, providing a low loss signal connection between the feed line 110 and the RF transmitter/receiver 112. In some examples, the feed line 110 includes a coaxial cable. The coaxial cable can include an additively manufactured conductor, an additively manufactured dielectric, and/or an additively manufactured conducting shield, which provide the feed line 110 during fabrication. In such examples, where the feed line 110 includes an additively manufactured integrated coaxial cable, the coaxial cable is hermetically sealed with a vacuum, an air, or a gas dielectric therein. In some other examples, the coaxial cable is sealed with a solid dielectric therein.

As noted above, the ground plane 102, the radiator 104, and the signal pin 106 are integral with or otherwise structurally unified with each other. The ground plane 102, the radiator 104, and the signal pin 106 can be integrated with each other, for example, using additive manufacturing to fabricate the ground plane 102, the radiator 104, and the signal pin 106 as a single contiguous unitary or monolithic structure of material or materials. Such a monolithic three-dimensional structure can be formed by depositing a quantity of material upon existing structures and provides smooth impedance tapers in any direction, to great benefit of antenna performance. For example, each quantity of material, also referred to as a structural pixel, can be located on the structure at a unique coordinate within a spherical coordinate system that can be expanded upon in any direction, as opposed to a layer-by-layer Cartesian construction or a subtractive process of material removal. The disclosed additive manufacturing process allows the antenna to incorporate intentional supports, modest bridges or overhang structures, intrinsic tunnels, intentional pockets, and high aspect ratio features. For example, the radiator 104 can have a continuous impedance taper away from the signal pin 106. Fabricating the antenna assembly 100 using additive manufacturing thus enables smooth convex, concave, linear, elliptical, exponential, and Klopfenstein tapers that are not possible to achieve using subtractive manufacturing due to the overhang geometry or limitations on drilling access. In some examples, the antenna assembly 100 can have a tapered (variable-width) signal pin 106 for implementing coaxial impedance matching circuits. In such examples, the taper of the signal pin 106 is continuous with the taper of the radiator 104.

Although additive manufacturing forms a unitary structure by depositing materials layer by layer, in some examples the ground plane 102, the radiator 104, and the signal pin 106 can comprise different materials that are deposited during fabrication to form a structurally continuous body of material, a structurally continuous arrangement of materials, or a structurally continuous combination of materials.

As used herein, the phrase “structurally continuous” includes bodies, arrangements, or combinations of materials that are additively manufactured to form a single contiguous unitary structure or component.

The cross-sectional profile of the radiator 104 can be varied. For example, the profile can be a convex, concave, or combination of convex and concave surfaces, such as shown in FIG. 1. The curvature of the radiator 104 surface determines the diffractive effect of the radiated signal as a logarithmic function of the distance of a given point on the surface from the signal pin 106.

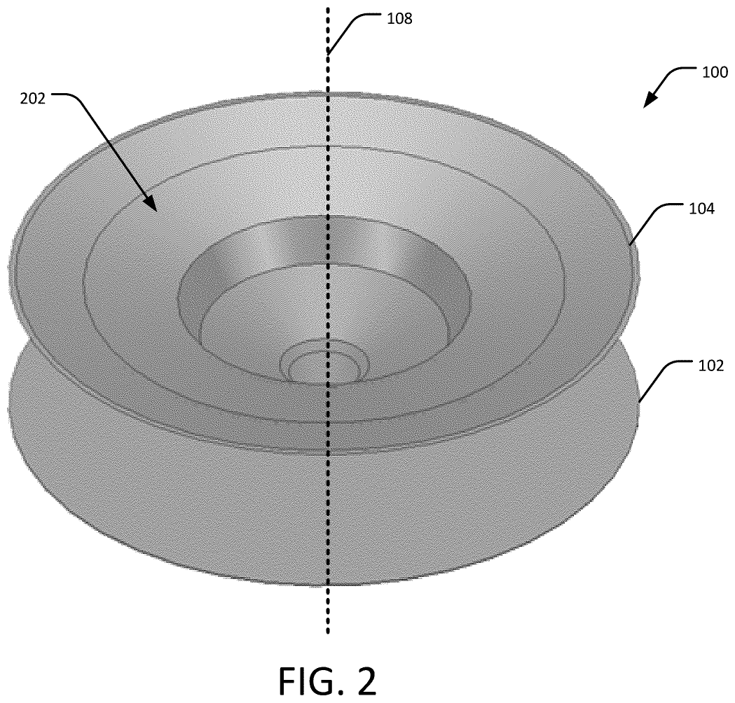

FIG. 2 is a top perspective view of the antenna assembly 100 of FIG. 1, in accordance with an example of the present disclosure. As noted above, the radiator 104 is a tapered structure that resembles an inverted hat or bowl. In this example, an interior region 202 of the radiator 104 is uncovered and hollow.

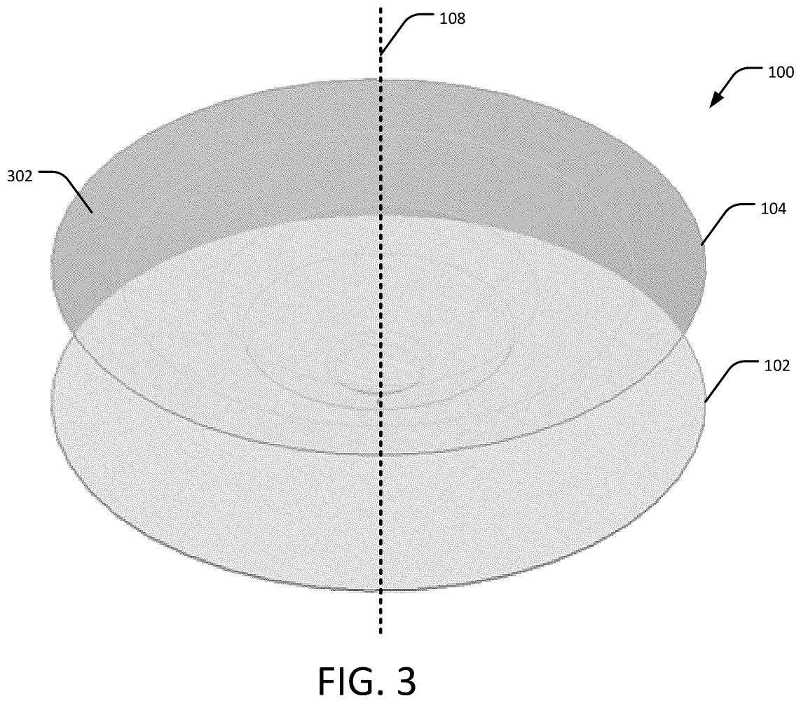

FIG. 3 is a top perspective view of the antenna assembly 100 of FIG. 1, in accordance with another example of the present disclosure. As noted above, the radiator 104 is a tapered structure that resembles an inverted hat or bowl. In this example, a cover 302 extends over the interior region of the radiator 104, enclosing the inverted hat. In some examples, the interior region of the radiator 104 can include a hollow region or a region at least partially filled with an infill material adjacent to one side (e.g., interior) of the tapered conductive surface of the radiator 104. The cover 302 and/or the infill material can be additively manufactured with the radiator 104.

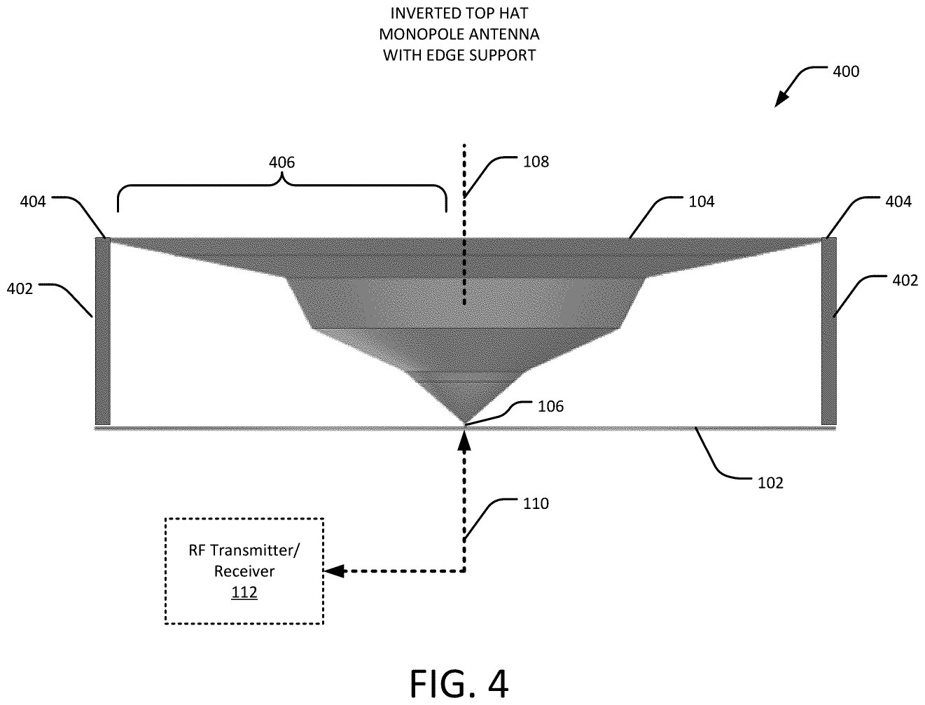

FIG. 4 is a side view of an antenna assembly 400, in accordance with an example of the present disclosure. The antenna assembly 400 is similar to the antenna assembly 100 of FIG. 1, and further includes one or more support structures 402 extending from the ground plane 102 to the tapered conductive surface of the radiator 104. The support structures 402 provide structural support between the ground plane 102 and the radiator 104. For example, the support structure 402 can be coupled to an outer edge 404 of the tapered conductive surface of the radiator 104. However, it will be understood that the support structure 402 can be coupled to other regions of the radiator 104, such as a region 406 between the signal pin 106 and the outer edge 404. It will be further understood that the support structure 402 can be a post-like structure extending between the ground plane 102 and the radiator 104, or a more complex structure, such as a lattice- or truss-like structure. The support structure 402 can be additively manufactured as a separate component or contiguously with the ground plane 102, the radiator 104, or both.

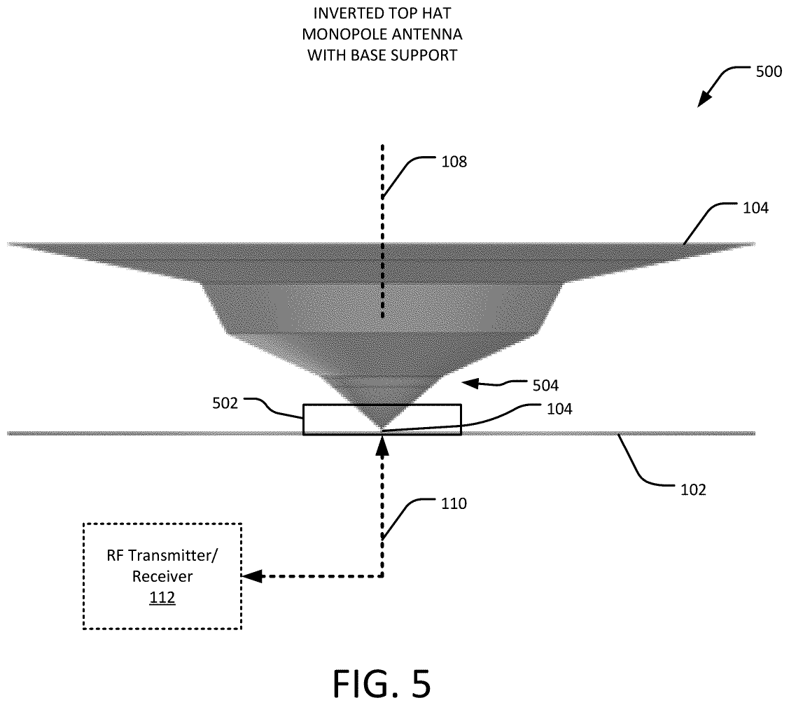

FIG. 5 is a side view of an antenna assembly 500, in accordance with an example of the present disclosure. The antenna assembly 500 is similar to the antenna assembly 100 of FIG. 1, and further includes one or more support structures 502 extending from the ground plane 102 to the tapered conductive surface of the radiator 104. The support structures 502 provide structural support between the ground plane 102 and a center, or base, region 504 of the radiator 104. For example, the support structure 502 can be coupled to the center region 504 of the tapered conductive surface of the radiator 104. The support structure 502 can have a shape that conforms to the shape of the downward-facing (toward the ground plane 102) surface of the center region 504 of the radiator 104, or the support structure 502 can include other structures, such as posts, beams, or other members that provide strength and rigidity for resisting forces applied to the ground plane 102 and/or the radiator 104. The center region 504 can, for example, include a portion of the radiator 104 immediately surrounding or otherwise adjacent to the signal pin 106. For example, the support structure 502 can be a circular conductor perpendicular to the axis 108. Such a circular structure acts as a reflector to shape the gain pattern of the radiating monopole. The size of the base can be varied to change the elevation peak of the gain pattern, with larger ground planes pushing the peak azimuth gain to lower angles in theta (with theta=0 defined as along the axis 108 looking upward from the support structure 502). In some examples, the support structure 502 can be physically connected to the radiator 104 through shorting pins that provide mechanical stability. In some other examples, no physical coupling is used between the support structure 502 and the radiator 104. In such cases, the radiator 104 can be supported by a dielectric support (e.g., an over-top cover bolted to the support structure 502, one or more non-conductive pins, or a non-conductive support at the bottom of the antenna assembly 100, 400, 500).

The support structure 502 can be additively manufactured as a separate component or contiguously with the ground plane 102, the radiator 104, or both. In some examples, the support structure 502 includes a solid dielectric material, such as ceramic, plastic, glass, mica, and/or a dielectric solid with sufficient structural strength and stability to resist relative movements between the ground plane 102 and the radiator 104 without fracturing or collapsing.

As noted above, the antenna assembly 100, 400, and 500 is configured to handle very high power (e.g., megawatts) without voltage breakdown, such as by avoiding or reducing the use of dielectrics in the structure of the antenna. The lack of dielectric materials in the radiating or support structures, such as the radiator 104, the support structure 402, and/or the support structure 502, allow for much higher voltage breakdowns than in antennas fabricated using certain existing techniques. For example, in printed control board (PCB) manufacturing, the thickness of the substrate must be calculated to survive high voltages, which complicates the circuit design process. However, with additive manufacturing, no such calculation is needed at least because the additively manufactured material (e.g., a metal) will not break down and the design of the antenna assembly 100, 400, 500 does not depend on any dielectric substrates to function.

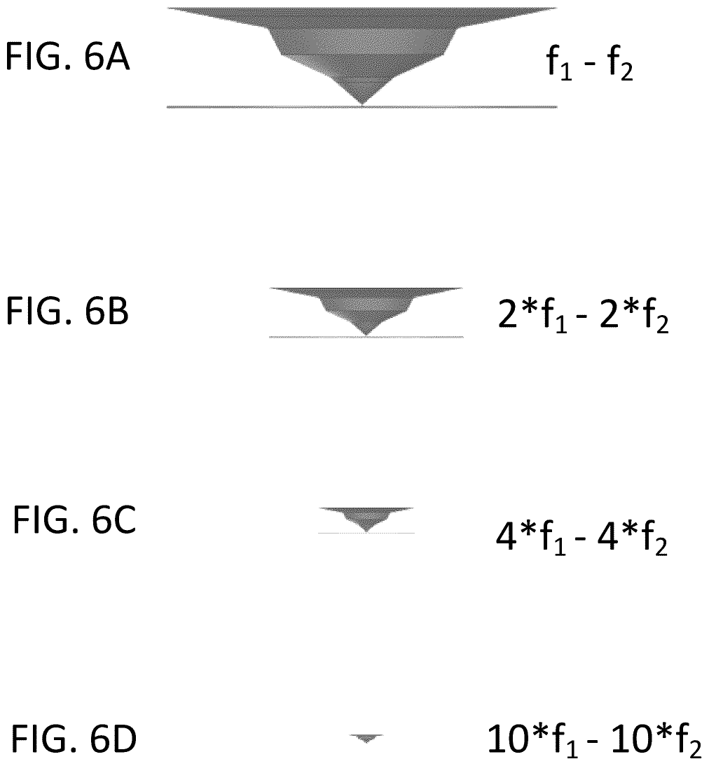

FIGS. 6A-D show the antenna assembly 100 of FIG. 1 fabricated at various scales, in accordance with examples of the present disclosure. As noted above, the antenna design can be wavelength scaled. For example, the antenna assembly 100 can be scaled linearly as a function of frequency. FIG. 6A shows the antenna assembly 100 at a first scale of frequency f₁-f₂. FIG. 6B shows the antenna assembly 100 at a second scale of frequency 2*f₁−2*f₂ (e.g., half-scale). FIG. 6C shows the antenna assembly 100 at a third scale of frequency 4*f₁−4*f₂ (e.g., quarter-scale). FIG. 6D shows the antenna assembly 100 at a fourth scale of frequency 10*f₁−10*f₂ (e.g., one-tenth scale). It will be appreciated that by using additive manufacturing techniques, the antenna assembly 100 can easily be fabricated at any scale without the need for additional modifications to the manufacturing tooling and assembly process. For example, other types of manufacturing processes, such as metal extrusion, injection molding, laser sintering, CNC machining, and so forth, require specialized product and production designs that are tailored for a given product specification. By contrast, additive manufacturing processes can be easily adapted to meet product specifications with a high degree of accuracy and complexity, as well as providing the ability to consolidate multiple parts into a monolithic or contiguous unitary structure or component, which reduces or eliminates cost and material waste while fabricating the final product.

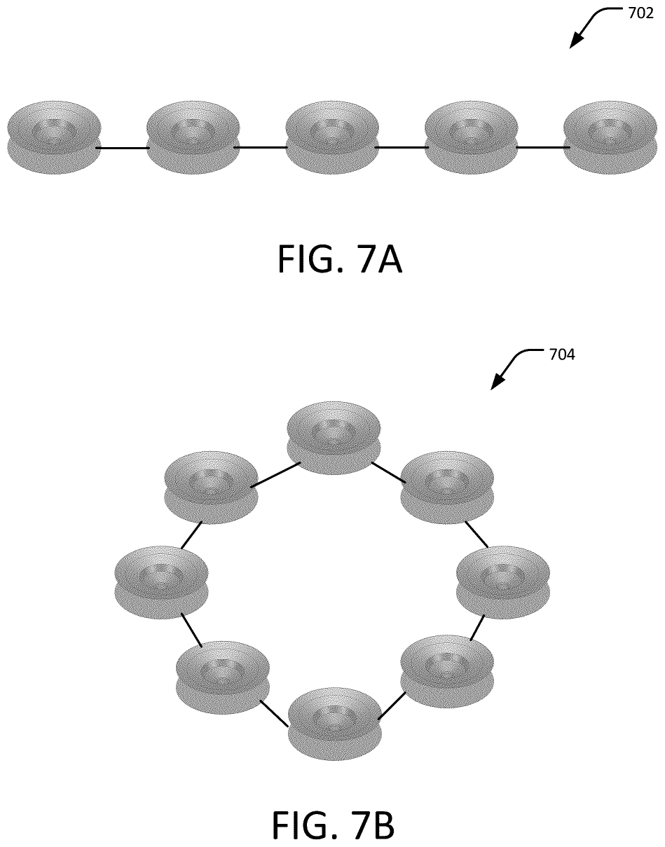

FIG. 7A shows the antenna assembly 100 of FIG. 1 arranged in a linear array 702, in accordance with an example of the present disclosure. FIG. 7B shows the antenna assembly 100 of FIG. 1 arranged in a circular array 704, in accordance with an example of the present disclosure. In these examples, multiple antenna assemblies are arranged in an array where the shape and direction of the radiation pattern can be controlled according to the relative phases and magnitudes of the input signal. Such examples can additionally or alternatively be used in direction finding applications, where the location of a source signal is triangulated from each antenna in the array by determining the angle at which the signal is received. In some examples, each of the antenna assemblies are integral with each other so as to form a contiguous unitary component.

### Antenna Fabrication Methodology

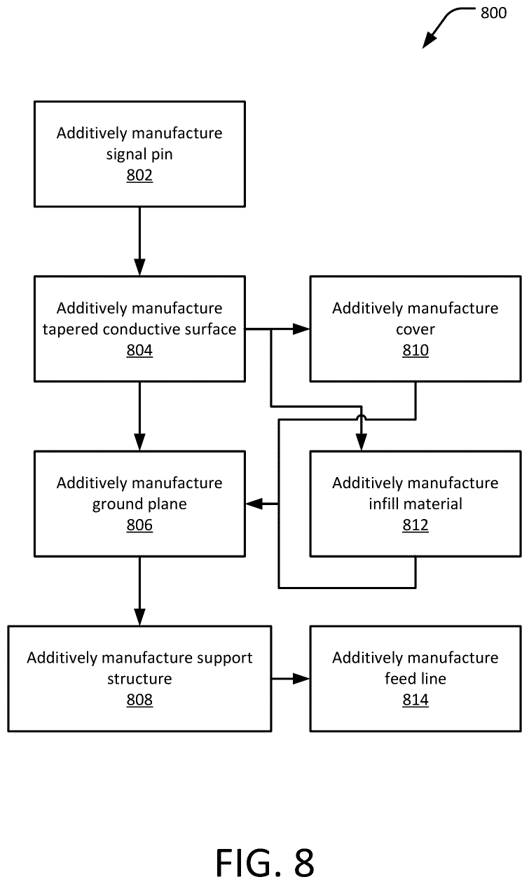

FIG. 8 is a flow diagram of a method 800 of fabricating an antenna assembly, in accordance with an example of the present disclosure. The antenna assembly fabricated by the method 800 can include, for example, the antenna assembly 100, 400, and/or 500 of FIGS. 1-5 or portions thereof. The method 800 includes additively manufacturing 802 a signal pin adjacent to a ground plane and additively manufacturing 804 a tapered conductive surface coupled to the signal pin, where the tapered conductive surface is symmetric about an axis passing through the signal pin and orthogonal to the ground plane and where the tapered conductive surface includes an additively manufactured material.

In some examples, the method 800 includes additively manufacturing 806 the ground plane. In some examples, the method 800 includes additively manufacturing 808 a support structure extending from the ground plane to the tapered conductive surface. The support structure can be coupled to an outer edge of the tapered conductive surface or to a center region of the tapered conductive surface.

In some examples the method 800 includes additively manufacturing 810 a cover over the tapered conductive surface thereby forming a hollow region between the cover and the tapered conductive surface. In some examples, the method 800 includes additively manufacturing 812 an infill material adjacent to one side of the tapered conductive surface. In some examples, the method 800 includes additively manufacturing 814 a feed line electrically coupled to the signal pin. In some examples, the feed line includes a coaxial cable hermetically sealed with a vacuum, an air, a gas, or a solid dielectric therein. In some other examples, a non-hermetic coaxial transmission line can be used.

In some examples, the additively manufactured material includes an additively manufactured solid piece of sheet metal, an additively manufactured printed circuit board (PCB), an additively manufactured dielectric plate that is metalized on one or both sides, or a combination of two or more of the sheet metal, PCB, and dielectric plate. In some examples, the feed line includes an additively manufactured conductor, an additively manufactured dielectric, and an additively manufactured conducting shield. In some examples, the coaxial cable is hermetically sealed with a vacuum, an air, or a gas dielectric therein, or with a solid dielectric therein.

### Further Examples

The following examples pertain to further examples, from which numerous permutations and configurations will be apparent.

Example 1 provides an antenna assembly comprising an electrically conductive ground plane; a signal pin adjacent to the ground plane; and a tapered conductive surface coupled to the signal pin, the tapered conductive surface being continuously tapered with respect to the signal pin, symmetric about an axis passing through the signal pin, and orthogonal to the ground plane, wherein the signal pin, the ground plane, and the tapered conductive surface are integral to each other as an additively manufactured a contiguous unitary component.

Example 2 includes the subject matter of Example 1, further comprising a support structure extending from the ground plane to the tapered conductive surface.

Example 3 includes the subject matter of Example 2, wherein the unitary component further includes the support structure.

Example 4 includes the subject matter of any one of Examples 2 and 3, wherein the support structure is coupled to an outer edge of the tapered conductive surface.

Example 5 includes the subject matter of any one of Examples 2-4, wherein the support structure is coupled to a center region of the tapered conductive surface.

Example 6 includes the subject matter of anyone of Examples 1-5, further comprising a cover over the tapered conductive surface thereby forming a hollow region between the cover and the tapered conductive surface.

Example 7 includes the subject matter of Example 6, wherein the unitary component further includes the cover.

Example 8 includes the subject matter of anyone of Examples 1-7, further comprising an infill material adjacent to one side of the tapered conductive surface, wherein the unitary component further includes the infill material.

Example 9 includes the subject matter of anyone of Examples 1-8, further comprising a feed line electrically coupled to the signal pin, wherein the feed line is integral with the unitary component.

Example 10 includes the subject matter of Example 9, wherein the feed line includes a coaxial cable hermetically sealed with a vacuum, an air, or a gas, or a solid dielectric therein.

Example 11 includes the subject matter of any one of Examples 1-10, further comprising an impedance matching element, wherein the impedance matching element is integral with the unitary component.

Example 12 provides a method of fabricating an antenna assembly, the method comprising additively manufacturing a tapered signal pin adjacent to a ground plane; and additively manufacturing a tapered conductive surface coupled to the signal pin, the tapered conductive surface being continuously tapered with respect to a taper of the signal pin, symmetric about an axis passing through the signal pin and orthogonal to the ground plane, the tapered conductive surface including an additively manufactured material.

Example 13 includes the subject matter of Example 12, further comprising additively manufacturing the ground plane, wherein the ground plane and the tapered conductive surface are a contiguous unitary component.

Example 14 includes the subject matter of any one of Examples 12 and 13, further comprising additively manufacturing a support structure extending from the ground plane to the tapered conductive surface.

Example 15 includes the subject matter of Example 14, wherein the support structure is coupled to an outer edge of the tapered conductive surface.

Example 16 includes the subject matter of any one of Examples 14 and 15, wherein the support structure is coupled to a center region of the tapered conductive surface.

Example 17 includes the subject matter of any one of Examples 12-16, further comprising additively manufacturing a cover over the tapered conductive surface thereby forming a hollow region between the cover and the tapered conductive surface.

Example 18 includes the subject matter of any one of Examples 12-17, further comprising additively manufacturing an infill material adjacent to one side of the tapered conductive surface.

Example 19 includes the subject matter of any one of Examples 12-18, further comprising additively manufacturing a feed line electrically coupled to the signal pin.

Example 20 includes the subject matter of Example 19, wherein the feed line includes a coaxial cable sealed with a vacuum, an air, a gas, or a solid dielectric therein.

Example 21 provides an antenna array assembly comprising a plurality of antenna assemblies arranged in an array, each of the antenna assemblies including an electrically conductive ground plane; a signal pin adjacent to the ground plane; and a tapered conductive surface coupled to the signal pin, the tapered conductive surface being symmetric about an axis passing through the signal pin and orthogonal to the ground plane, wherein the signal pin, the ground plane, and the tapered conductive surface are integral to each other as an additively manufactured a contiguous unitary component.

Example 22 includes the subject matter of Example 21, wherein each of the antenna assemblies are integral with each other so as to form a contiguous unitary component.

Numerous specific details have been set forth herein to provide a thorough understanding of the examples. It will be understood, however, that other examples may be practiced without these specific details, or otherwise with a different set of details. It will be further appreciated that the specific structural and functional details disclosed herein are representative of examples and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims. Furthermore, examples described herein may include other elements and components not specifically described, such as electrical connections, signal transmitters and receivers, processors, or other suitable components for operation of the modular antenna.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and examples have been described herein. The features, aspects, and examples are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. An antenna assembly comprising:
an electrically conductive ground plane;
a signal pin adjacent to the ground plane; and
a tapered conductive surface coupled to the signal pin, the tapered conductive surface being continuously tapered with respect to the signal pin, symmetric about an axis passing through the signal pin, and orthogonal to the ground plane,
wherein the signal pin, the ground plane, and the tapered conductive surface are integral to each other as an additively manufactured contiguous unitary component.

2. The antenna assembly of claim 1, further comprising a support structure extending from the ground plane to the tapered conductive surface.

3. The antenna assembly of claim 2, wherein the unitary component further includes the support structure.

4. The antenna assembly of claim 2, wherein the support structure is coupled to an outer edge of the tapered conductive surface.

5. The antenna assembly of claim 2, wherein the support structure is coupled to a center region of the tapered conductive surface.

6. The antenna assembly of claim 1, further comprising a cover over the tapered conductive surface thereby forming a hollow region between the cover and the tapered conductive surface.

7. The antenna assembly of claim 6, wherein the unitary component further includes the cover.

8. The antenna assembly of claim 1, further comprising an infill material adjacent to one side of the tapered conductive surface, wherein the unitary component further includes the infill material.

9. The antenna assembly of claim 1, further comprising a feed line electrically coupled to the signal pin, wherein the feed line is integral with the unitary component.

10. The antenna assembly of claim 9, wherein the feed line includes a coaxial cable hermetically sealed with a vacuum, an air, a gas, or a solid dielectric therein.

11. The antenna assembly of claim 1, further comprising an impedance matching element, wherein the impedance matching element is integral with the unitary component.

12. A method of fabricating an antenna assembly, the method comprising:
additively manufacturing a tapered signal pin adjacent to a ground plane; and
additively manufacturing a tapered conductive surface coupled to the signal pin, the tapered conductive surface being continuously tapered with respect to a taper of the signal pin, symmetric about an axis passing through the signal pin, and orthogonal to the ground plane, the tapered conductive surface including an additively manufactured material.

13. The method of claim 12, further comprising additively manufacturing the ground plane, wherein the ground plane and the tapered conductive surface are a contiguous unitary component.

14. The method of claim 12, further comprising additively manufacturing a support structure extending from the ground plane to the tapered conductive surface.

15. The method of claim 14, wherein the support structure is coupled to at least one of an outer edge of the tapered conductive surface and a center region of the tapered conductive surface.

16. The method of claim 12, further comprising additively manufacturing a cover over the tapered conductive surface thereby forming a hollow region between the cover and the tapered conductive surface.

17. The method of claim 12, further comprising additively manufacturing an infill material adjacent to one side of the tapered conductive surface.

18. The method of claim 12, further comprising additively manufacturing a feed line electrically coupled to the signal pin, wherein the feed line includes a coaxial cable sealed with a vacuum, an air, a gas, or a solid dielectric therein.

19. An antenna array assembly comprising:
a plurality of antenna assemblies arranged in an array, each of the antenna assemblies including
an electrically conductive ground plane;
a signal pin adjacent to the ground plane; and
a tapered conductive surface coupled to the signal pin, the tapered conductive surface being symmetric about an axis passing through the signal pin and orthogonal to the ground plane,
wherein the signal pin, the ground plane, and the tapered conductive surface are integral to each other as an additively manufactured contiguous unitary component.

20. The antenna array assembly of claim 19, wherein each of the antenna assemblies are integral with each other so as to form a contiguous unitary component.
